(19) United States
(12) Patent Application Publication
(10) Pub. No.: US 2021/0221228 A1
(43) Pub. Date: Jul. 22, 2021

(54) A USER INTERFACE FOR VEHICLES

(71) Applicant: MOGEES LTD, London (GB)

(72) Inventors: Conor BARRY, London (GB); Bruno ZAMBORLIN, London (GB); Parag MITAL, Valencia, CA (US); Baptiste CARAMIAUX, Paris (FR); Alessandro SACCOIA, Brescia (IT)

(21) Appl. No.: 16/760,554

(22) PCT Filed: Oct. 31, 2018
(86) PCT No.: PCT/GB2018/053146

§ 371 Date: Apr. 30, 2020

(30) Foreign Application Priority Data
Oct. 31, 2017 (GB) 1718006.8

(51) Int. Cl. B60K 37/06; B60K 35/00; G01H 11/00; G06F 3/01

(52) U.S. Cl. CPC B60K 37/06; B60K 35/00; G01H 11/00; B60K 2370/794; B60K 2370/158; B60K 2370/157; G06F 3/016

(57) ABSTRACT

The present invention relates to a method for providing a user interface for a vehicle. The method includes the steps of detecting vibration signals from a user control action on a surface of the vehicle at a vibration sensor; processing the vibration signals to determine features of the user control action; and triggering a control event based upon the determination of features of the user control action.

### FIELD OF INVENTION

The present invention is in the field of user interfaces. More particularly, but not exclusively, the present invention relates to user interfaces for vehicles.

### BACKGROUND

Vehicle interiors include a user interface comprising a number of controls to enable a user (such as a driver or passenger) to control functions of the vehicle. These functions include control of vehicle elements such as indicators, road lights, horn, window wipers, windows (e.g. opening/closing), air conditioning and stereo.

These controls are traditionally implemented through buttons, switches, and dials. The controls are typically electrically wired to the element. Some controls may be mechanically connected to the element (e.g. crank-based window openers and flap-based air conditioners).

These traditional controls have a number of disadvantages:
Buttons, switches, and other traditional user interfaces for vehicle control can wear over time, break, and receive water damage.
Traditional vehicle user interfaces (e.g. buttons/switches) limit the possibilities to the vehicle manufacturer in terms of aesthetics and ergonomics of the vehicle interior.
By using buttons, switches and traditional user interfaces, the area of control is restricted to the area of those specific elements.
Buttons, switches, and traditional controls restrict the range of possible user interactions (e.g. pressing a button, holding a switch).
Traditional controls (e.g. dials, buttons, joysticks, sliders) are commonly limited to one or two output actions per control (e.g one button to lock/unlock doors, one switch to roll up/down window).
Traditional controls restrict users to interactions that are pre-defined (e.g. the user can only press a button). Furthermore this interaction is usually mapped to a pre-defined function (e.g. turn on hazard lights).
Introducing new components and user interfaces to a car interior or exterior commonly requires significant modifications to be made to the design and manufacture of the interior or exterior.

Next user interfaces have been developed to attempt to solve some of these problems. These include gestural control interfaces which use visual or infrared camera tracking to detect user's hand positions and actions. Users then perform gestural actions without touching any element of the vehicle. However, gestural control interfaces lack tangible feedback to the user, and can therefore be difficult to use. Another interface uses capacitive sensing. A capacitive sensing interface uses charged capacitive materials that when touched cause a fluctuation in capacitance and can detect touch. These are merely an alternative to buttons that do not require moving parts, and do not address all of the disadvantages above.

U.S. Pat. No. 8,855,855 (Hyundai Motor Company) describes a sound wave touch pad which uses custom surface patterns to generate sounds that can be uniquely identifiable.

It is an object of the present invention to provide a user interface for vehicles which overcomes the disadvantages of the prior art, or at least provides a useful alternative.

### SUMMARY OF INVENTION

According to a first aspect of the invention there is provided a method for providing a user interface for a vehicle, including:

a) detecting vibration signals from a user control action on a surface of the vehicle at a vibration sensor;

b) processing the vibration signals to determine features of the user control action; and

c) triggering a control event based upon the determination of features of the user control action.

Other aspects of the invention are described within the claims.

### BRIEF DESCRIPTION OF THE DRAWINGS

Embodiments of the invention will now be described, by way of example only, with reference to the accompanying drawings in which:

FIG. 1a: shows a flow diagram illustrating a method in accordance with an embodiment of the invention;

FIG. 1b: shows a block diagram illustrating a system in accordance with an embodiment of the invention;

FIG. 2: shows a photograph of a car door illustrating a method in accordance with an embodiment of the invention;

FIG. 3: shows a diagram illustrating vibration sensor placement in accordance with some embodiments of the invention; and

FIGS. 4a to 4d:

show a diagrams illustrating different hardware configurations for systems in accordance with embodiments of the invention.

### DETAILED DESCRIPTION OF PREFERRED EMBODIMENTS

The present invention provides a method and system for providing a user interface for vehicles.

The inventors have discovered that vibration sensors can be used to detect vibration signals from a user action on the surface of the vehicle. The inventors have discovered that the vibration signals can be processed to determine features of the user control action which can be used to trigger a pre-determine control event for the vehicle. In this way, the vibration sensor can be placed anywhere vibrations can be transmitted from the surface.

The control event may be to control specific functions of a receiving device inside the vehicle (e.g. radio/music, alarm, window, locks, AC, doors, opening hood, windscreen wipers, hazard lights, lights, infotainment, phones) or outside the vehicle (e.g. gates/garage doors, mobile phones).

The surface of the vehicle may be the interior or exterior of the vehicle.

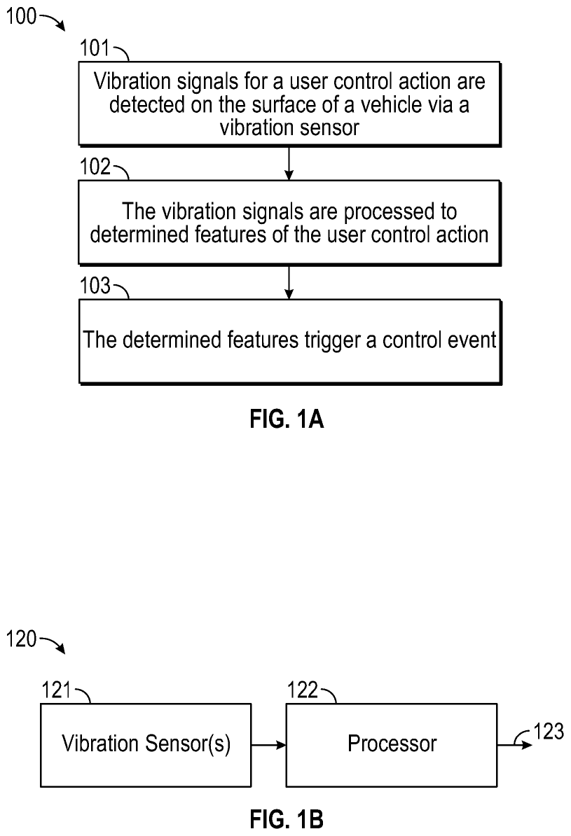

Referring to FIG. 1a, a method 100 for providing a user interface for a vehicle in accordance with an embodiment of the invention will be described.

In step 101, vibrations signals are detected on the surface of the vehicle. The vibration signals are detected at a vibration sensor (e.g. piezo element, MEMS, coil microphone, and/or electret microphone). The signals may be detected at one of a plurality vibration sensors or at multiple vibration sensors.

The vibration sensor may be a vibration transducer which uses one method selected from the set of capacitive, piezoelectric, electrostatic, fibre-optic, electromagnetic, visual, carbon, laser, and MEMS.

The vibration sensor may be embedded, attached on, or attached underneath a first element forming the surface or another element which is connected to the first such that vibrations can be transmissible between the elements.

The vibration signals may be formed by a user control action. The user control action may be a direct action by a user upon the surface. For example, a gesture by the user on the surface such as a discrete contact (e.g. tap, scratch, or knock) or continuous contact (e.g. scraping or swiping). The user control action may be an indirect action by the user upon the surface. For example, via an exciter. The exciter may be in the possession of the user (such as a stick) or it may be on or within the surface (such as a switch, slider, button, or joystick). The exciter may generate vibration signals via a mechanical action.

In step 102, the vibration signals are processed to determine features of the user control action.

The features may include type of user control action (e.g. tap or scratch), location (e.g. where on the surface the user control action occurred), intensity (e.g. hard tap versus a soft tap), duration (e.g. fast swipe versus slow swipe), and pattern (e.g. two taps or one tap and one scratch—which may be within specific time periods).

Types of user control action may include:

Direct:
Index finger tap
Middle finger tap
Side of thumb tap
Flat of index finger tap
Flat of middle finger tap
Minor knuckle tap
Major knuckle tap
Hand slap
Finger scratch
Nail scratch
Finger slide
Circular finger slide
Index finger flick
Sitting down
Footsteps
Kicks
Elbow hits
Head-butts
Punches
Flat hand swipes
Side of hand chops
Side of finger chops (with 1, 2, 3, 4 fingers)

Indirect:
Moving panels
Clicking buttons or mechanical switches
Knocking over an object that impacts the surface
Flicking an object that impacts the surface
Opening/closing objects that impact the surface (e.g. door/boot/hood)

The user control action may be one user control action of many, and the vibration signals may be processed to distinguish which user control action is received.

In step 103, a control event is triggered based upon the determination of features of the user control action.

The control event may be a vehicle control event. The vehicle control event may control the functions of an element within the vehicle. The user control action may be received at the surface of that element.

Examples of specific user control actions triggering specific vehicle control events include:
Slide door handle up—window up/visa versa
Tap window to roll down, tap window shelf to roll up
Tap windscreen to turn on/off de-mister
Right finger tap to answer call. Right knuckle tap to dismiss call or hang up
Tap on armrest in different positions to lock/unlock specific doors.

A set of control events may be triggered based upon the determination of features of the user control action. The set of control events may be predefined by the user or another user of the vehicle. For example, a triple tap on the dashboard might turn on the road lights, start the windscreen wipers, and shut all car windows. This may be configured by a user to quickly configure the vehicle for rain conditions.

Embodiments of the invention may include the step of a user defining the user control action for the control event. This may be done by a user assigning a predefined user control action to a predefined control event, defining a user control action via performance and assigning it to a predefined control event, and/or reassigning a predefined user control action from one control event to another.

Embodiments of the invention may include the step of detecting additional signals from the user control action at one or more other non-vibration sensors, such as capacitance, temperature IR, visual, sound and/or movement sensors, and using all signals to determine features of the user control action.

In FIG. 1b, a system 120 in accordance with an embodiment of the invention is shown.

The system 120 may include one or more vibration sensors 121. The vibration sensors 121 may be in direct or indirect physical contact with a surface of a vehicle. The surface may be an interior or exterior surface of the vehicle, such as a door panel, car dashboard, or exterior panelling. The vibration sensors 121 may be configured to detect vibrations generated by user control actions on the surface of the vehicle.

The system 120 may also include a processor 122 configured to receive signals from the vibration sensor(s) 121, process the signals to determine features of the user control actions, and trigger control events 123 based upon the determination of features of the user control actions.

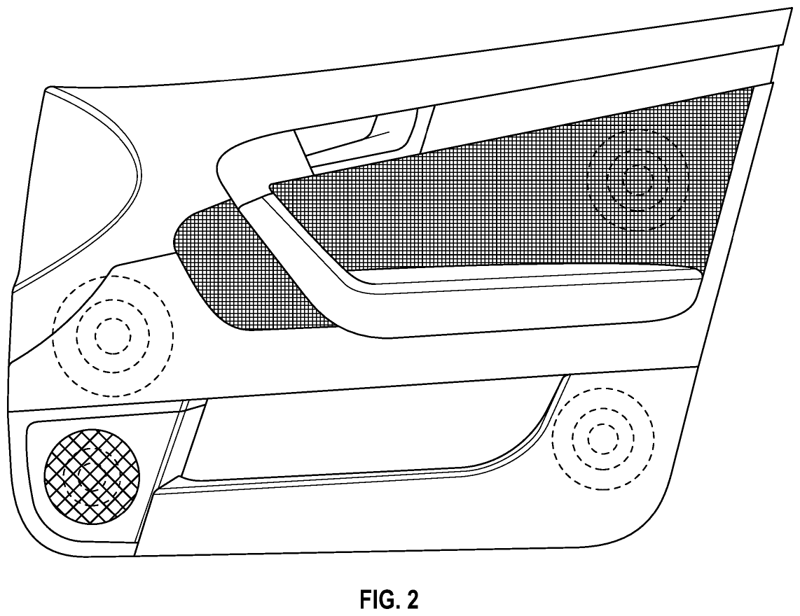

FIG. 2 illustrates a car door with various locations indicated with numerals. Embodiments of the present invention may detect vibration signals at each location at a vibration sensor within the car door and perform one or more of the following functions:

1. Tap #26 with finger to lock/unlock this door.

2. Knock/Rap knuckles on #26 to lock/unlock all doors.

3. Swipe/run finger from #45 to #31 to turn stereo volume up halfway. Swipe up to #30 to set it to full volume.

4. Swipe finger in a clockwise small circle around “Y” to turn on AC at low power with high temperature. Swipe in a large clockwise circle to turn on at high power.

5. Swipe in an anti-clockwise circle to lower temperature.

In embodiments, a vehicle manufacturer may implement a set of pre-defined user actions or the user can define their own actions to perform pre-defined output events or user defined output events.

For example:

1: Pre-Defined Input, Pre-Defined Output.

Manufacturer has pre-defined that whenever the user slaps the centre of the dashboard, to turn the hazard lights on/off.

2: Pre-Defined Input, User Defined Output.

Manufacturer has pre-defined that whenever the user slaps the centre of the dashboard, and output event can occur. The user can configure or re-assign this action to control an output event of their choice (e.g. turn on the radio).

The user would likely use a separate interface to configure the output control (e.g. touchscreen display)

3: User Defined Input, Pre-Defined Output.

The manufacturer has pre-defined that any user action within a certain context can be used to control a specific output event, e.g. turning the hazard lights on. The user can then define their own action to control the hazard lights. One user may choose to tap the top of the steering wheel to turn them on. Another user may decide to knock the central console to turn them on.

4: User Define Input, User Defined Output.

Through a separate interface, the user can dictate to the processor which action they would like to perform to control whichever output event they wish. This means they can perform an input event of their choice (e.g. swipe) and select the output control(s) they wish.

For example, a user may progress through a separate (maybe touchscreen) interface, tell the processor “I'm going to perform a new user action”. The processor would then listen and learn the new action by recording the representation of the vibration pattern when the user performs it. The user would then select through the console one or more output events from a selection, or potentially perform one or more other pre-configured actions to determine the output. So Joe could tell the car, whenever I swipe here, move the seat to this position and put on this radio station. Joe (or another user) could record another action to control another set of actions.

In embodiments, vibration signals may be processed within FIG. 1 to determine features of the user control action and these features used to determine a control event using one or more of the following methods.

Version 1:

One or more representations of vibration patterns are stored on the processing unit. Incoming vibrations are translated into representations of vibration patterns and compared to the stored representations, a corresponding control event is output by the processor.

Version 2:

One or more representations of vibrations patterns are stored on the processing unit. Incoming vibrations are translated into representations of vibration patterns. These representations are compared to the stored representations. If the representation is similar or matches a stored vibration pattern, the processor outputs a corresponding control event. If the representation does not match or is similar to a stored representation, a default control event or no control event is output.

Embodiments of the Invention can be Immune from Noise:

In order to separate vibration patterns created by intentional user actions vs vibrations that were not, representations of these patterns are compared to an existing set of representative vibration patterns. If the incoming pattern does not correspond with a representation of a vibration pattern caused by an intentional user action, it is discarded or causes the output of a default control event.

How Action Detection can Work:

A user action creates vibrations that are detected by the vibration sensor. The vibration sensor converts this into a signal for the processing unit. The processing unit performs transient and/or amplitude detection to identify vibrations created by user actions.

How Intensity Detection can Work:

A user action creates vibrations that are detected by the vibration sensor. The vibration sensor converts this into a signal for the processing unit. The processing unit performs amplitude analysis to detect the output amplitude of the user action.

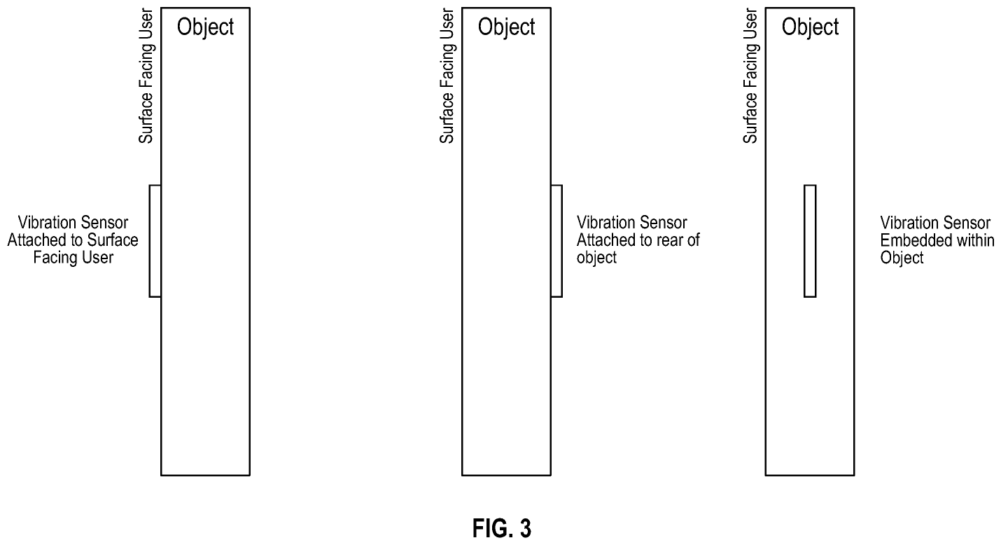

Referring to FIG. 3, the vibration sensor may be attached in any of three different ways for some embodiments of the invention.

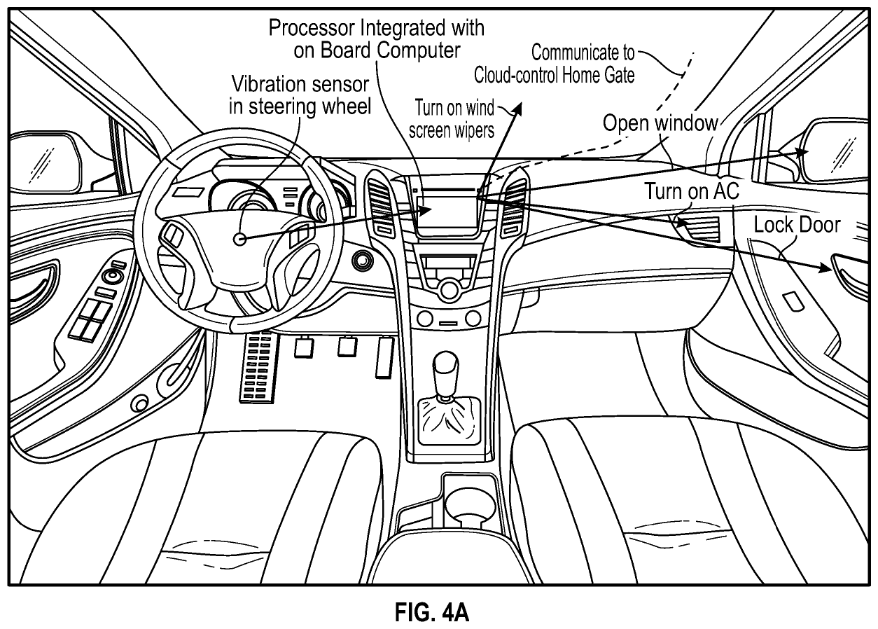

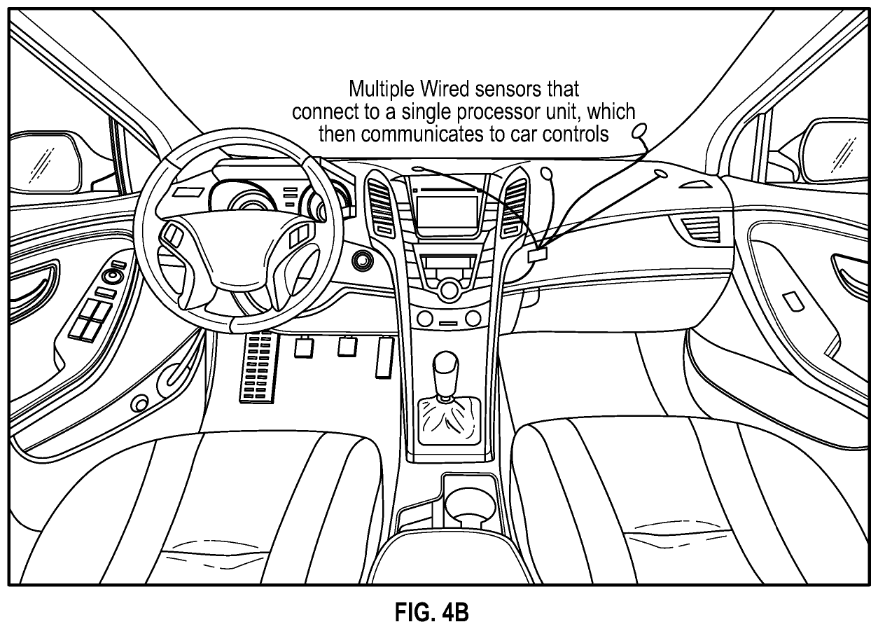

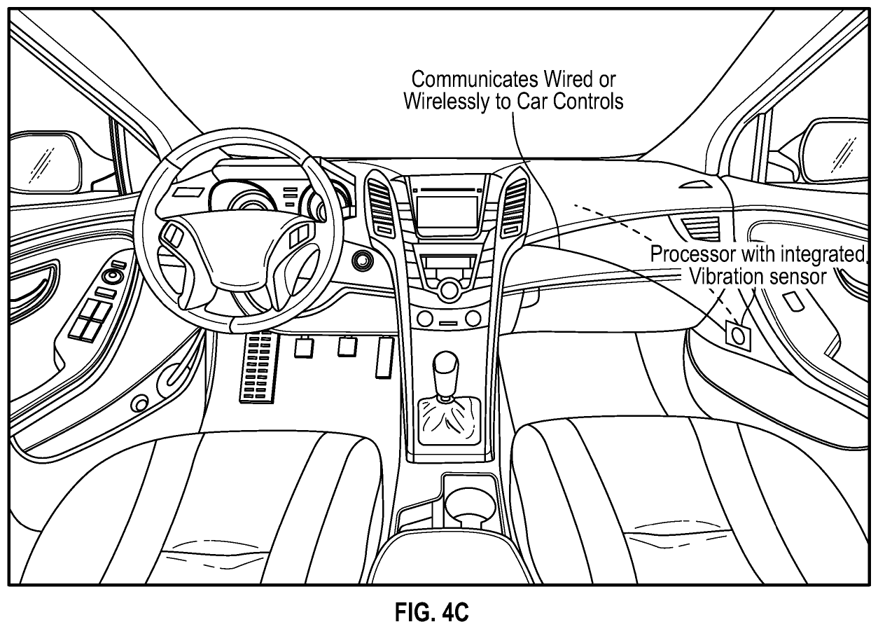

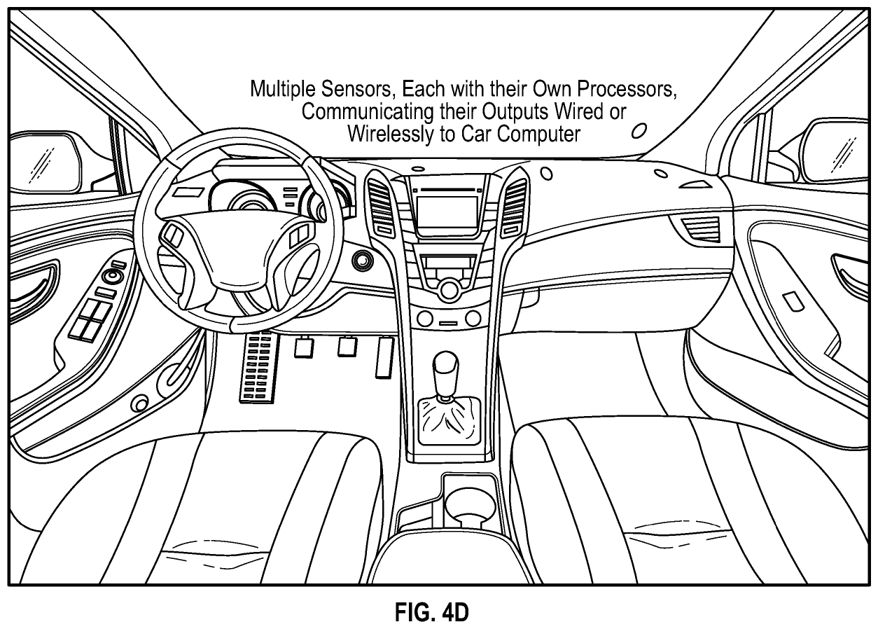

Referring to FIGS. 4a to 4d, various hardware configurations for the system will be shown.

Potential advantages of some embodiments of the present invention include that:
1. This device removes the need for buttons or switches by embedding vibration sensor(s) behind or inside elements of the vehicle interior/exterior. In this way, the user is interacting directly with the vehicle interior/exterior (e.g. the steering wheel, the door panel, the dashboard, window), removing the need for any moving parts. This greatly reduces the potential for damaged or broken parts.
2. By using vibrations generated when the user's actions, the manufacturer is free to design vehicle interiors or exteriors without needing to integrate components specifically designed for user interfaces.
3. Vibrations can travel through entire objects or surfaces, allowing for the area of interaction to be as large as the entire object or surface.
4. Multiple locations of contact can be detected and associated to distinct/discrete outputs. Continuous interactions such as swipes/slides can translate directly to continuous controls such as audio volume or window height.
5. With this device/method, this range can be extended to additional interactions (e.g. taps, knocks, swipes, slides, scrapes, slaps, hard tap/soft tap, double/triple taps, moving panels, stick hits). Each of these different interactions can be distinguished by our device/methods as unique, and therefore be associated to different events/outputs/controls/actions.
6. With this device every combination of gesture and/or position can be associated to distinct output actions (e.g. tap a first position to control left window, tap a second position to control right window, swipe to lower volume).
7. With this device there is the opportunity for users to define new interactions (e.g. the user can decide the location and type of gesture they perform). Furthermore this interaction can be mapped to a function of their choice. For example user A can define the hazard lights to be controlled by tapping on the left side of the dashboard. User B can choose to define the hazard lights to be controlled by knocking on the right side of the dashboard.
8. This device is easily embeddable and/or retrofit-able.
9. It does not require major modifications to be made to existing vehicle interior or exterior designs.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of applicant's general inventive concept.

1-32. (canceled)

33. A method for providing a user interface for a vehicle, including:
a) detecting vibration signals from a user control action on a surface of the vehicle at a vibration sensor;
b) processing the vibration signals to determine features of the user control action; and
c) triggering a control event based upon the determination of features of the user control action.

34. A method as claimed in claim 33, wherein the vehicle surface is not specially modified or configured.

35. A method as claimed in claim 33, wherein the user control action is a gesture or direct action on the surface by a user.

36. A method as claimed in claim 33, wherein the user control action is interaction with an object that generates a vibration on the surface.

37. A method as claimed in claim 36, wherein the object is a mechanical user interface object.

38. A method as claimed in claim 37, wherein the object is embedded at the surface of the vehicle, and wherein the object is one or more selected from a switch, a slider, a button and a joystick.

39. A method as claimed in claim 33, wherein the control event is a vehicle control event.

40. A method as claimed in claim 33, wherein the surface of the vehicle is the interior surface of the vehicle.

41. A method as claimed in claim 33, wherein the features of the user control action includes one or more selected from the set of type, location, intensity, duration, and pattern.

42. A method as claimed in claim 33, wherein the surface of the vehicle is a surface of a first element of the vehicle and the vibration sensor is embedded on, behind, or inside the first element.

43. A method as claimed in claim 33, wherein the surface of the vehicle is a surface of a first element of the vehicle and the vibration sensor is embedded on, behind, or inside a second element connected to the first element such that vibrations are transmissible from the first element to the second element.

44. A method as claimed in claim 33, wherein the surface of the vehicle is a surface of a first element of the vehicle, the first element includes a function and wherein the control event controls the function of the first element.

45. A method as claimed in claim 33, further including the step of a user defining the user control action for the control event.

46. A method as claimed in claim 45, wherein the user defines the user control action by performing the user control action on the surface of the vehicle.

47. A method as claimed in claim 33, wherein the user defines the user control action by selecting the user control action from a set of user control action options.

48. A method as claimed in claim 33, wherein the user defines the control event by selecting the control event from a set of control events.

49. A method as claimed in claim 33, wherein the vibration sensor is a vibration transducer which uses one method selected from the set of capacitive, piezoelectric, electrostatic, fibre-optic, electromagnetic, visual, carbon, laser, and MEMS.

50. A method as claimed in claim 33, further including the step of detecting additional signals from the user control action at one or more other sensors and processing the additional signals to determine features of the user control action; wherein the control event is triggered based additionally on the determination of features of the user control action from the additional signals.

51. A method as claimed in claim 33, wherein the vibration signals are detected from the user control action on the surface of the vehicle at one of a plurality of vibration sensors.

52. A method as claimed in claim 33, wherein a set of control events are triggered based upon the determination of features of the user control action.

53. A system for providing a user interface for a vehicle, including:
One or more vibration sensors configured to associate with a surface of a vehicle and to detect vibration signals from a user control action on the surface; and
A processor configured to process the vibration signals to determine features of the user control action and trigger a control event based upon the determination of features of the user control action.
